(19) United States
(12) Patent Application Publication
(10) Pub. No.: US 2017/0206812 A1
(43) Pub. Date: Jul. 20, 2017

(54) PHOTOLUMINESCENT SIGNAGE

(71) Applicant: Zachary L. Green, Cincinnati, OH (US)

(72) Inventor: Zachary L. Green, Cincinnati, OH (US)

(21) Appl. No.: 15/320,859

(22) PCT Filed: Jun. 17, 2015
(86) PCT No.: PCT/US2015/036174

§ 371 Date: Dec. 21, 2016

Related U.S. Application Data
(60) Provisional application No. 62/024,563, filed on Jul. 15, 2014.

(51) Int. Cl. G09F 13/20

(52) U.S. Cl. CPC G09F 13/20

(57) ABSTRACT

A non-powered photoluminescent sign includes a clear substrate and a message. The message is positioned on a surface of the clear substrate. The message is defined by at least one opaque portion. At least one of the at least one opaque portion is photoluminescent. The message is viewable with ambient light and without ambient light. Methods and other photoluminescent signs are also provided.

### REFERENCE TO RELATED APPLICATION

This application claims priority of U.S. provisional patent application Ser. No. 62/024,563, filed Jul. 15, 2014, and hereby incorporates this provisional patent application by reference herein in its entirety.

### TECHNICAL FIELD

Embodiments of the technology relate, in general, to photoluminescent signage having both clear portions and opaque portions, where the opaque portions convey a message. More particularly, embodiments of the technology relate to non-powered photoluminescent signage.

### BACKGROUND

Various types of illuminated signs can be used for indicating location of safety equipment and other objects, showing directions for normal or emergency egress, and/or providing warnings. These signs can act as important safety measures, particularly during emergencies. Existing signs may require electricity or some other source of power to illuminate or display the information contained thereon. However, such conventional signs are deficient in several ways. For example, powered signage can be expensive to install and maintain. Additionally, should the power source be interrupted or otherwise fail to function, the sign may not adequately serve its purpose during emergency or non-emergency situations. Finally, the general aesthetics of the signage may be undesirable for a particular space or usage.

### BRIEF DESCRIPTION OF THE DRAWINGS

It is believed that certain embodiments will be better understood from the following description taken in conjunction with the accompanying drawings, in which like references indicate similar elements and in which:

FIGS. 1-3 depict example photoluminescent signs in accordance with various non-limiting embodiments.

FIG. 4 depicts an example photoluminescent sign having a message that is applied to the clear substrate.

FIGS. 5 and 6 depict exploded views of example photoluminescent signs.

FIG. 7 depicts an example photoluminescent sign positioned in an environment having sufficient ambient lighting.

FIG. 8 depicts the photoluminescent sign of FIG. 7 with no ambient lighting.

FIGS. 9-11 show an example photoluminescent sign in accordance with the present disclosure.

### DETAILED DESCRIPTION

Various non-limiting embodiments of the present disclosure will now be described to provide an overall understanding of the principles of the structure, function, and use of photoluminescent signage disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Described herein are example embodiments of photoluminescent signage and methods of manufacture. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. For ease of reading and clarity, certain components, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The present disclosure is generally directed to non-powered photoluminescent signs that do not utilize external or on-board power sources. As described in more detail below, the photoluminescent signs can have a generally clear substrate on which a message is applied. The message can comprise photoluminescent graphics, letters, or combinations thereof. The particular message can vary depending on application or use. Example messages can indicate points of egress, indicate location of objects (such as stairs, fire alarms, fires hoses, or fire extinguishers), or otherwise provide information to a viewer of the photoluminescent sign. Since the message is photoluminescent, it is viewable in situations where there is little to no ambient lighting, as may be experienced during an emergency event. In some embodiments, the only portion of the photoluminescent sign that is opaque is the message. In other embodiments, other portions of the photoluminescent sign besides the message can be opaque, such as points of attachment and other generally incidental portions. In some embodiments, the opaque portions of the photoluminescent signs are substantially photoluminescent. In some embodiments, the photoluminescent portions of the opaque portions are outlined by a border, such as a reflective border.

FIGS. 1-3 depict example photoluminescent signs in accordance with various non-limiting embodiments. As is to be appreciated, the particular font, size and layout of the photoluminescent signs described herein can vary based on application. Referring first to FIG. 1, a photoluminescent sign 100 has a transparent or clear substrate 102. The clear substrate 102 can be any suitable material that provides the desired rigidity and aesthetics, such as glass, plastic, acrylic, Plexiglas® or Lexan™, for example. The size of clear substrate 102 can be any suitable size. In some embodiments, the height of the clear substrate 102 can be in the range of about 6 inches to about 14 inches. In some embodiments, the width of the clear substrate 102 can be in the range of about 6 inches to about 14 inches. In some embodiments, the thickness of the clear substrate 102 can be in the range of about ⅛ inch to about ½ inch. The photoluminescent sign 100 also has a message 104 that is applied, printed or otherwise attached to the clear substrate 102. The size of the message 104 can depend, for example, on a desired visibility distance. In some embodiments, the message 104 is about 6 inches high. The message 104 can be positioned on either the front surface of the clear substrate 102 (as shown) or the rear surface of the clear substrate 102. The message 104 can be photoluminescent such that the message 104 is viewable in low-light conditions. The photoluminescent sign 100 has translucent portions and opaque portions. The opaque portions are defined by the message 104 and the translucent portions are defined by the portions of the clear substrate 102 that are not covered by the message 104.

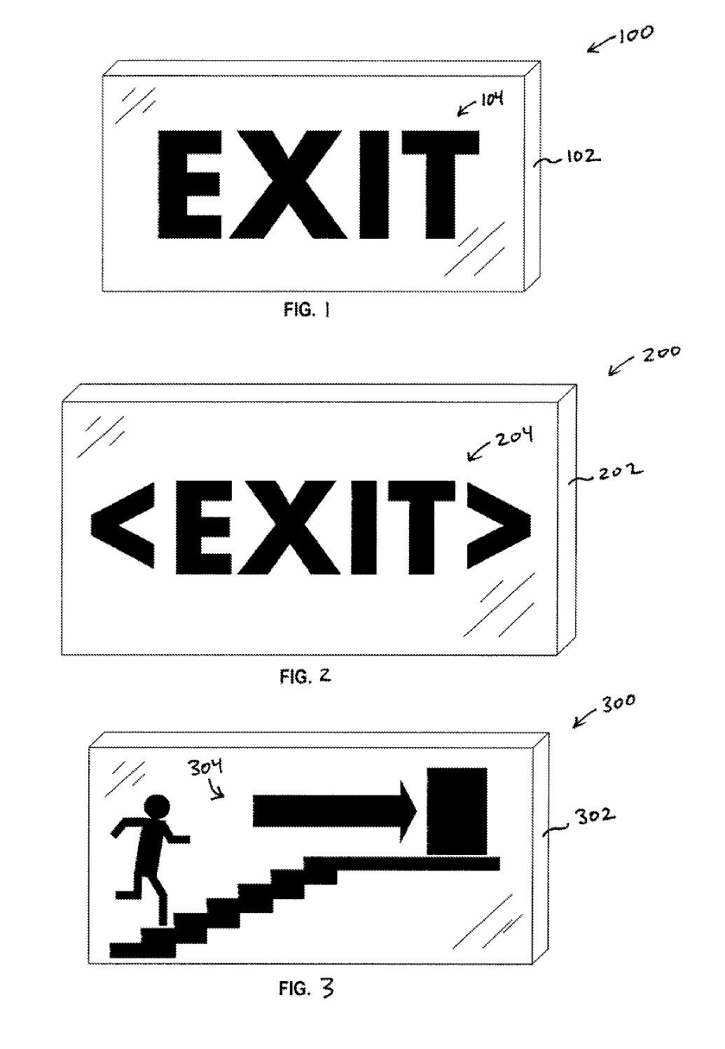

The particular message delivered by the photoluminescent signage described herein can vary based on application. FIG. 2, for example, depicts an example embodiment of a photoluminescent sign 200 having a message 204 that comprises both text and graphics. The photoluminescent sign 200 is generally similar to the photoluminescent sign 100 and has a clear substrate 202. The example message 204 depicted in FIG. 2 includes directional arrows in addition to text. FIG. 3 depicts an example embodiment of a photoluminescent sign 300 that has a non-text message 304. Similar to FIG. 1 and FIG. 2, the photoluminescent sign 300 has a clear substrate 302 on which the message 304 is applied.

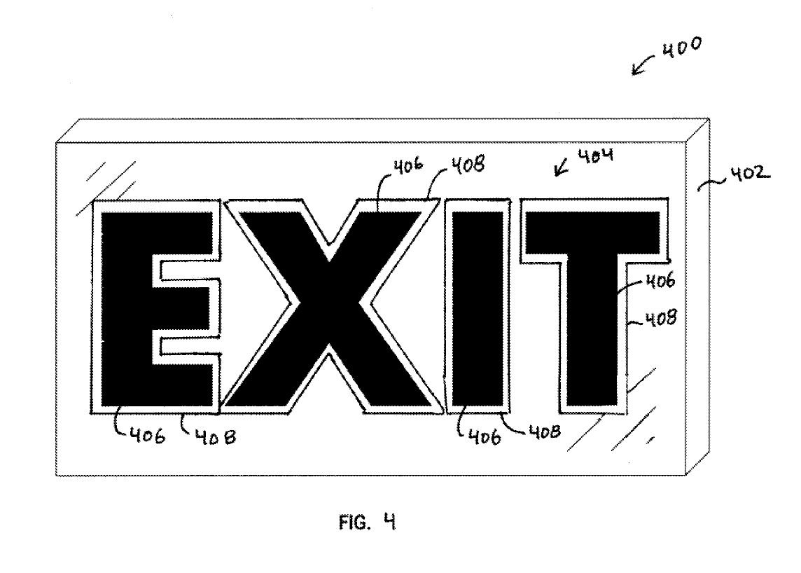

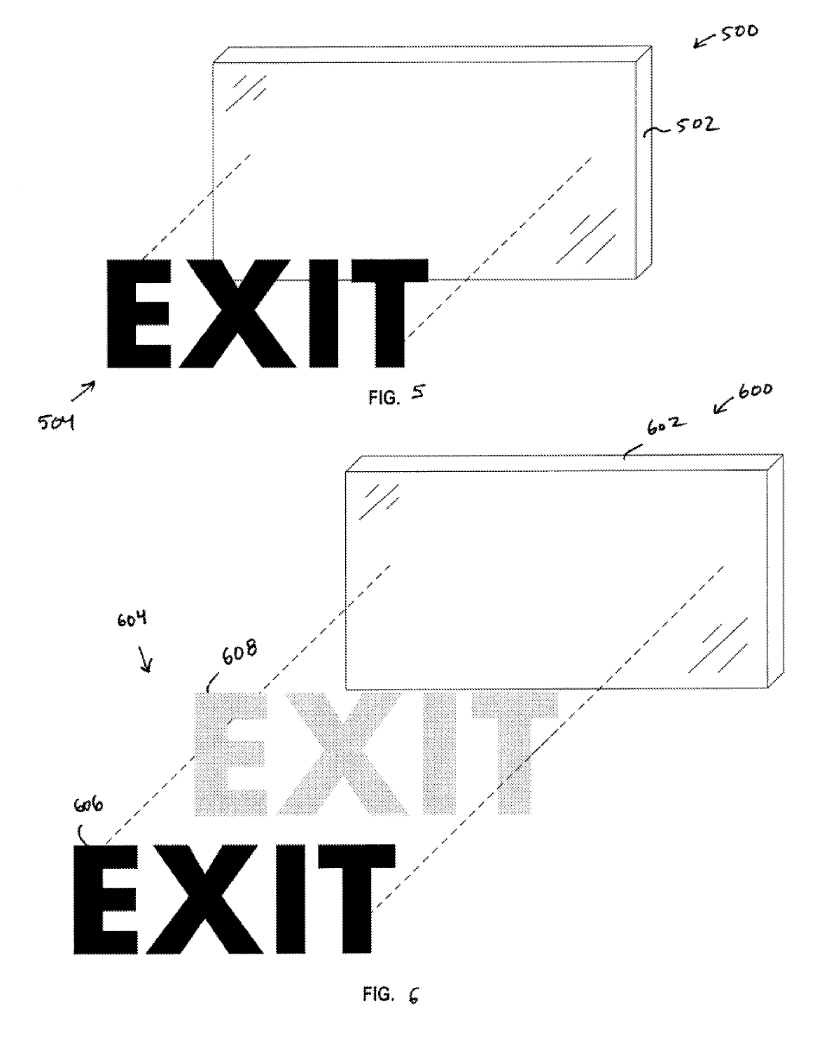

In some embodiments the entire message is photoluminescent, while in other embodiments a portion of the message is photoluminescent and the remaining portion of the message is opaque. FIG. 4 depicts an example photoluminescent sign 400 having a message 404 that is applied to the clear substrate 402. The message 404 includes a photoluminescent portion 406 and an opaque portion 408 that is not photoluminescent. In the illustrated embodiment, the opaque portion 408 is a border around each letter in the message. As is to be appreciated, similar opaque portions can also border graphical elements, such as directional arrows, stairs, and the like. In some embodiments the opaque portion 408 comprises a reflective material to aid in visibility. For example, the opaque portion 408 can be colored reflective film, such as a red or green film. In other embodiments, the opaque portion 408 can be white, black, or any other suitable color. The particular thickness of the opaque portion 408 relative to the photoluminescent portion 406 can vary. As depicted in FIG. 4, in some embodiments, the photoluminescent portion 406 can dominate the visual impression of the message. In some embodiments, the border portions of the message can be photoluminescent and the interior portions of the message can be non-photoluminescent.

FIGS. 5 and 6 depict exploded views of example photoluminescent signs. The photoluminescent sign 500 has a message 504 that is entirely photoluminescent whereas the photoluminescent sign 600 has a message 604 that comprises both photoluminescent portions 606 and opaque portions 608. Referring first to FIG. 5, the letters of the message 504 are a vinyl-type film that is infused with photoluminescent pigment. During manufacturing, the letters of the message 504 are applied to the clear substrate 502 using any suitable adhesive or bonding agent. In some embodiments, pressure can be applied to the letters of message 504 using a roller or other technique to remove air bubbles and wrinkles. Referring now to FIG. 6, the letters of opaque portion 608 of the message 604 can be sized to be larger than the photoluminescent portions 606 of the message. In one embodiment, the photoluminescent portions 606 can be joined with the opaque portions 608 and then the assembly is applied to the clear substrate 602. In another embodiment, the opaque portions 608 are first applied to the clear substrate 602 and then the photoluminescent portions 606 are subsequently applied to the clear substrate 602 such that they overlay the opaque portions 608.

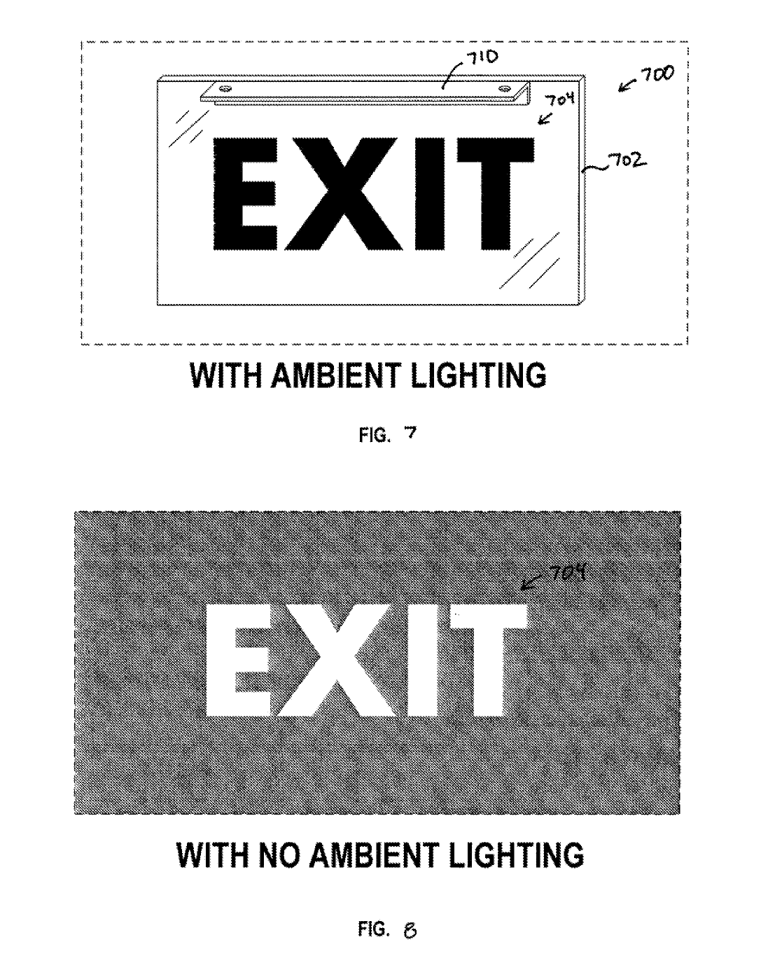

FIG. 7 depicts an example photoluminescent sign 700 positioned in an environment having sufficient ambient lighting. The photoluminescent sign 700 has a mounting bracket 710 to assist with securing the photoluminescent sign 700 to a structure. Other types of mounting brackets or fixtures can be used. FIG. 8 depicts the photoluminescent sign 700 with no ambient lighting. As shown, the message 704 is viewable due to its photoluminescence.

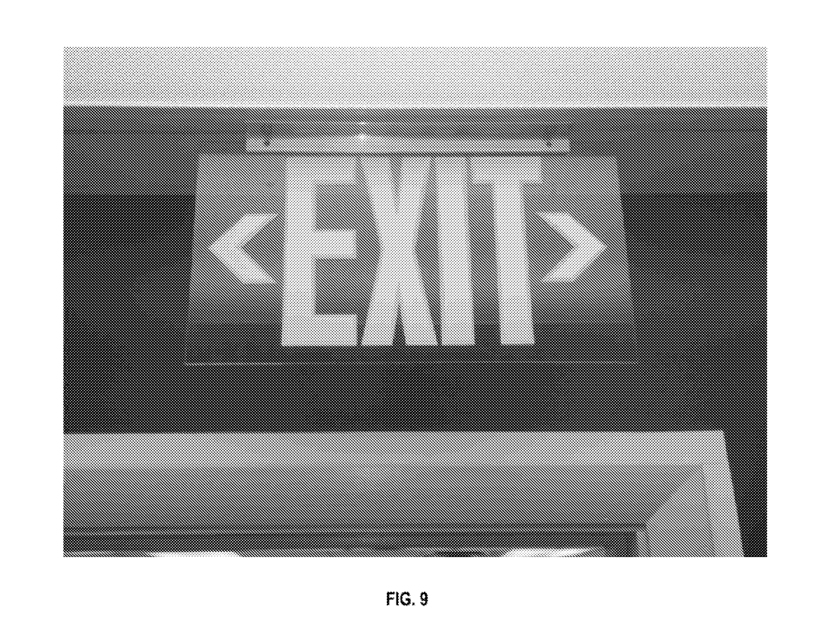

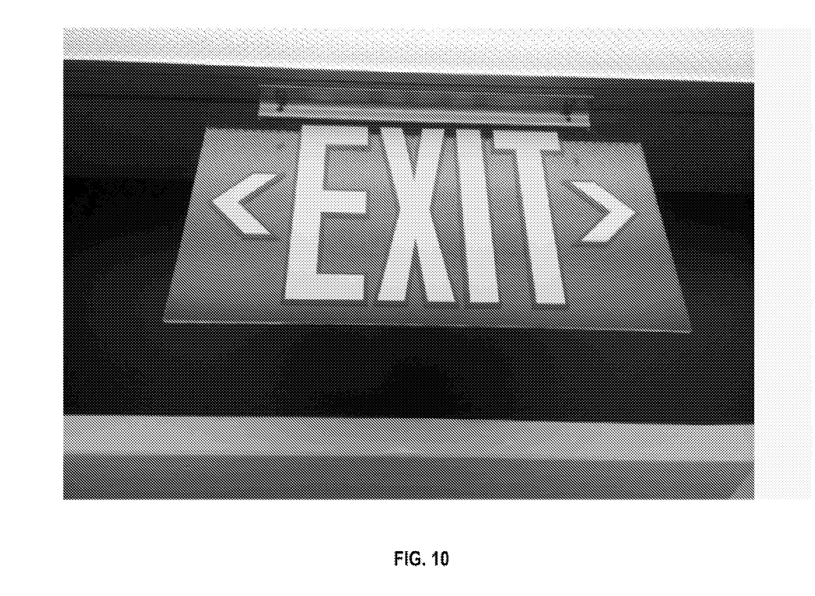

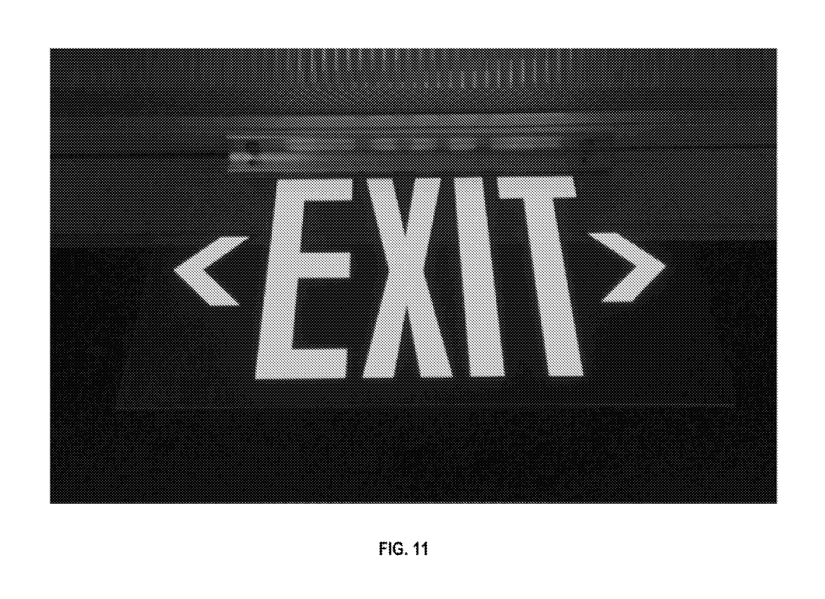

FIGS. 9-11 show an example photoluminescent sign in accordance with the present disclosure. FIGS. 9-10 depict the photoluminescent sign having a green reflective border around photoluminescent letters. FIG. 11 depicts the photoluminescent sign in a low light condition.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

1. A non-powered photoluminescent sign comprising:
a clear substrate; and
a message positioned on a surface of the clear substrate; wherein
the message is defined by at least one opaque portion;
at least one of said at least one opaque portion is photoluminescent; and
the message is viewable with ambient light and without ambient light.

2. (canceled)

3. (canceled)

4. (canceled)

5. (canceled)
